(19) United States
(12) Patent Application Publication
(10) Pub. No.: US 2016/0276100 A1
(43) Pub. Date: Sep. 22, 2016

(54) GRAIN BOUNDARY DIFFUSION TREATMENT JIG AND CONTAINER FOR GRAIN BOUNDARY DIFFUSION TREATMENT JIG

(71) Applicants: INTERMETALLICS CO., LTD., Nakatsugawa-shi, Gifu (JP); DAIDO STELL CO., LTD., Nagoya-shi, Aichi (JP)

(72) Inventors: Masato SAGAWA, Kyoto-shi (JP); Shinobu TAKAGI, Niwa-gun (JP)

(21) Appl. No.: 14/777,595

(22) PCT Filed: Mar. 13, 2014
(86) PCT No.: PCT/JP2014/056703

§ 371 Date: Sep. 16, 2015

(30) Foreign Application Priority Data
Mar. 18, 2013 (JP) 2013-055738

(51) Int. Cl. H01F 41/02; C21D 10/00; C23C 10/28; H01F 1/057

(52) U.S. Cl. CPC H01F 41/0293; H01F 1/0577; C21D 10/00; C23C 10/28

(57) ABSTRACT

A grain boundary diffusion treatment jig that does not easily become fused with a base material an R^{L}₂Fe₁₄B system magnet having a surface coated with an adhesion material containing an element R^{H} when subjected to a heating process for grain boundary diffusion treatment. The grain boundary diffusion treatment jig includes a plate-shaped base having a surface with projections arranged so that the tips of the projections lie in one plane. Since the contact area between the adhesion material applied to the surface of the base material and the grain boundary diffusion treatment jig is reduced by the use of the projections for supporting the base material, and since a ceramic material that does not easily react with the adhesion material is used, the fusion of the base material and the grain boundary diffusion treatment jig is less likely to occur in the aforementioned heating process.

### TECHNICAL FIELD

The present invention relates to a jig used in a grain boundary diffusion treatment in which a heavy rare-earth element R^{H} (which is at least one element selected from the group of Dy, Tb and Ho) is diffused through the boundaries of the main phase grains of an R^{L}FeB system magnet into regions near the surfaces of the main phase grains whose main phase is made of R^{L}₂Fe₁₄B containing a light rare-earth element R^{L} (which is at least one element selected from the group of Nd and Pr) as its main rare-earth element. It also relates to a container for containing a plurality of such jigs.

### BACKGROUND ART

RFeB system magnets were discovered in 1982 by Sagawa (one of the present inventors) and other researchers. The magnets have the characteristic that most of their magnetic characteristics (e.g. residual magnetic flux density) are far better than those of other conventional permanent magnets. Therefore, RFeB system magnets are used in a variety of products, such as driving motors for hybrid or electric automobiles, battery-assisted bicycle motors, industrial motors, voice coil motors (used in hard disk drives or other apparatuses), high-grade speakers, headphones, and permanent magnetic resonance imaging systems.

Earlier versions of the RFeB system magnet had the defect that the coercivity H_{cJ} was comparatively low among various magnetic properties. Later studies have revealed that a presence of a heavy rare-earth element R^{H} within the RFeB system magnet makes reverse magnetic domains less likely to occur and thereby improves the coercivity. The reverse magnetic domain has the characteristic that, when a reverse magnetic field opposite to the direction of magnetization is applied to the RFeB system magnet, it initially occurs in a region near the boundary of a grain and subsequently develops into the inside of the grain as well as onto the neighboring grains. Accordingly, it is necessary to prevent the initial occurrence of the reverse magnetic domain. To this end, R^{H} only needs to be present in regions near the boundaries of the grains so that it can prevent the reverse magnetic domain from occurring in the regions near the boundaries of the grains. On the other hand, increasing the R^{H} content unfavorably reduces the residual magnetic flux density Br and consequently decreases the maximum energy product (BH)ₘₐₓ. Increasing the R^{H} content is also undesirable in that R^{H} are rare elements and their production sites are unevenly distributed globally. Accordingly, in order to increase the coercivity (and thereby impede the formation of the reverse magnetic domain) while decreasing the R^{H} content to the lowest possible level, it is preferable to make the R^{H} exist at high concentrations more in a region near the surface (grain boundary) of the grain rather than in deeper regions.

Patent Literature 1 discloses a method of diffusing R^{H} atoms through the grain boundaries of an RFeB system magnet into regions near the surfaces of the grains by applying a coating material prepared by dispersing a fine powder of an R^{H} or R^{H} compound in an organic solvent, to the surface of the RFeB system magnet, and heating the RFeB system magnet together with the coating material. Such a method of diffusing R^{H} atoms through the grain boundaries into regions near the grains is called the “grain boundary diffusion method.” An RFeB system magnet before being subjected to the grain boundary diffusion treatment is hereinafter called the “base material” and is distinguished from an RFeB system magnet which has undergone the grain boundary diffusion treatment.

There are three major types of RFeB system magnets: (i) a sintered magnet, which is produced by sintering a raw-material alloy powder mainly composed of the main phase grains; (ii) a bonded magnet, which is produced by molding a raw-material alloy powder with a binder (made of a polymer, elastomer or similar organic material) into a solid shape; and (iii) a hot-deformed magnet, which is produced by performing a hot-deforming process on a raw-material alloy powder. Among these types, the grain boundary diffusion treatment can be performed on (i) the sintered magnet and (iii) the hot-deformed magnet, which do not contain any binder made of an organic material in the grain boundaries.

### CITATION LIST

### Patent Literature 1: WO 2011/136223 A

### SUMMARY OF INVENTION

### Technical Problem

In the grain boundary diffusion treatment, applying the coating material to the entire surface of the base material or to both sides of a plate-shaped base material enables R^{H} atoms to be spread over broader areas in the grain boundaries of the RFeB system magnet than applying the coating material to only a portion of the base material or to only one side of the plate-shaped base material. However, it causes the problem that, when a heating process for the grain boundary diffusion treatment is performed, the coating material on the surface of the base material inevitably comes in contact with a jig which supports the base material, so that a reaction occurs between the jig and the coating material, causing fusion of the jig and the base material. In Patent Literature 1, the base material covered with the coating material is placed on a jig having a number of pointed supports to minimize the contact area between the coating material and the jig. However, even with such a device, it is difficult to prevent the fusion of the jig and the base material. In an experiment of the grain boundary diffusion treatment (with a treating temperature of 900° C.) conducted by the present inventors, the fusion occurred even when an aforementioned type of jig made of any of the high-melting-point metals of Mo (melting point, 2610° C.), W (3387° C.) and Nb (2468° C.) was used.

In the grain boundary diffusion treatment, it is also possible to directly adhere a powder of R^{H} or R^{H} compound to the surface of the base material or to form a film of R^{H} metal or R^{H}-containing alloy on the surface of the base material by chemical vapor deposition or a similar method, instead of applying the coating material described in Patent Literature 1 to the surface of the base material. Such a coating material, powder, film or other forms of material to be adhered to the surface of the base material in the grain boundary diffusion treatment are hereinafter collectively called the “adhesion material.”

The problem to be solved by the present invention is to provide a grain boundary diffusion treatment jig that does not easily become fused with a base material coated with an adhesion material containing an element R^{H} even when subjected to the heating process for grain boundary diffusion treatment.

### Solution to Problem

The grain boundary diffusion treatment jig according to the present invention developed for solving the previously described problem is a plate-shaped jig for a grain boundary diffusion treatment performed in such a manner that an adhesion material containing a heavy rare-earth element R^{H} which is at least one element selected from the group of Dy, Tb and Ho is adhered to the surface of a base material which is a sintered or hot-deformed R^{L}₂Fe₁₄B system magnet containing, as a main rare-earth element, a light rare-earth element R^{L} which is at least one element selected from the group of Nd and Pr, and the base material with the adhesion material is heated, the jig configured to support the base material in the heating process, wherein:

the jig includes a plate-shaped base having a surface with a number of projections arranged so that the tips of the projections lie in one plane, and the surfaces of the tips are made of a ceramic material.

Although ceramic materials are more difficult to be machined than metal, they have the advantage that they hardly react with the R^{H}-containing adhesion material at the heating temperature used in the grain boundary diffusion treatment. In the present invention, the tip surface of the projection is made of such a ceramic material, whereby the jig is prevented from reacting with the coating material in the grain boundary diffusion treatment, so that the jig will not be easily fused with the base material.

For example, the ceramic material may be alumina, zirconia, titania, silcon carbide, silicon nitride, aluminum nitride, silica, magnesia, yttria, or a compound or mixture of two or more of these materials. Examples of the compound include: mullite (3Al₂O₃.2SiO₂), cordierite (2MgO.2Al₂O₃. 5SiO₂), and steatite (MgO.SiO₂). Using a ceramic material with a higher degree of purity is preferable since it makes fusion less likely to occur. This is due to the fact that a higher degree of purity means a smaller number of voids and defects present within the ceramic material and hence a lower probability of the adhesion material entering the voids or the like, so that the fusion is less likely to occur. The purity of the ceramic material should preferably be 90% or higher, and more preferably 99.5% or higher. For example, there will be little chance of fusion with the base material if the surface of the projection is made of a ceramic material with a 99.5% or higher purity of alumina, zirconia, silicon carbide, silicon nitride, aluminum nitride, silica, magnesia, yttria, or a compound or mixture of two or more of these materials.

The projection may be entirely made of a ceramic material. Alternatively, the projection may be a projection-shaped member having a tip coated with a ceramic material different from the material of the projection-shaped member. As the material of the projection-shaped member, a non-ceramic material may also be used, such as metal (e.g. tungsten or stainless steel) or carbon, or a ceramic material different from the one used for the coating may also be used.

Although the projection may have a pillar-like shape, it is more preferable to use a projection having a point-like contact portion, such as a pyramid-like, or convex projection, in order to decrease its contact area with the base material. A projection having a linear contact portion (straight or curved) may also be used. Although such a projection has a larger contact area with the base material than a projection having a pyramid-like or similar shape, it has the advantages that (i) it is resistant to breakage, (ii) it can support the base material in a stable form, and (iii) it can be easily created with a milling machine or similar device.

The projections may be formed on both the obverse and reverse sides of the plate-shaped base. With such a jig, base materials and jigs can be alternately stacked in a pile, so that a large number of base materials can be simultaneously subjected to the grain boundary diffusion treatment. In this case, the positions of the projections on one side of the base should preferably be displaced from those on the other side. Providing the projections at the same positions on both sides causes the heat capacity of the plate-shaped base to considerably vary between the area with no projection (flat area) and the area with projections on both sides, and thereby allows thermal strain to easily occur in a heating or cooling process.

However, stacking too many base materials and jigs yields a considerable load on the base materials and jigs in lower tiers, and may eventually damage those base materials and/or jigs. Accordingly, a jig container which is hereinafter described should preferably be used.

The present jig container is a jig container for containing the previously described grain boundary diffusion treatment jig, including:

a frame;

an upper engaging portion and a lower engaging portion respectively provided in the upper and lower portions of the frame, the upper and lower engaging portions capable of being engaged with each other; and

a supporting portion extending from the frame into the inner space of the frame, the supporting portion configured to support the base of the grain boundary diffusion treatment jig at least at a portion of the circumferential edge of the base,

wherein the pitch height of the jig containers with the upper and lower engaging portions engaged with each other is greater than the sum of the height of the base material to be subjected to the grain boundary diffusion treatment and the height of the grain boundary diffusion treatment jig.

This jig container can be used in a piled form, with one jig container stacked on another, within which a grain boundary diffusion treatment jig on which base materials coated with an adhesion material are placed is supported by the supporting portion. The load of the grain boundary diffusion treatment jigs, base materials and other elements in the upper tier is supported by the frame and will not act on the base materials or grain boundary diffusion treatment jigs. Therefore, the base materials and the grain boundary diffusion treatment jigs in the lower tiers will not be broken even in the piled form.

The present jig container cannot only be used for a grain boundary diffusion treatment jig having projections only on the upper side of the base, but also for a grain boundary diffusion treatment jig having projections on both the upper and lower (obverse and reverse) sides of the base. In the latter case, the height of the grain boundary diffusion treatment jig is defined by the vertical distance from the tips of the projections on the lower side of the base to those of the projections on the upper side of the base. The latter case has the advantage that, if there is only a narrow gap between a base material and the upper grain boundary diffusion treatment jig (i.e. the grain boundary diffusion treatment jig located immediately above the one on which the base material in question is placed), fusion will not easily occur even if they come in contact with each other. Therefore, the latter configuration allows the pitch height of the jig container to be equal to the sum of the height of the base material and that of the grain boundary diffusion treatment jig, i.e. the upper side of the base material may come in contact with the projections on the lower side of the base of the grain boundary diffusion treatment jig located immediately above.

The present jig container cannot only be used for the grain boundary diffusion treatment jig according to the present invention but also for conventional grain boundary diffusion treatment jigs.

In the grain boundary diffusion treatment, such a pile of jig containers are heated, with the base materials and grain boundary diffusion treatment jigs contained. Since the jig containers do not come in direct contact with the base materials in this treatment, it is unnecessary to use a ceramic material for the containers. Preferably, a material with high heat conductivity (e.g. carbon) should be used for the container so that the heat can be efficiently conducted to the contained base materials. Even if carbon is used as the material of the container, the container will not be burned in the grain boundary diffusion treatment, since the heating process for this treatment is performed in vacuum or in an inert-gas atmosphere to prevent oxidization of the base materials.

### Advantageous Effects of the Invention

The grain boundary diffusion treatment jig according to the present invention improves the efficiency of grain boundary diffusion treatment, since this jig does not easily become fused with base materials coated with an adhesion material containing an element R^{H} in the grain boundary diffusion treatment. The jig container according to the present invention enables the grain boundary diffusion treatment to be performed on base materials stacked in a pile, whereby the efficiency of grain boundary diffusion treatment will be further improved.

### BRIEF DESCRIPTION OF DRAWINGS

FIGS. 1A, 1B and 1C are respectively a perspective view, side view and top view of the first embodiment of the grain boundary diffusion treatment jig according to the present invention.

FIGS. 2A and 2B are respectively a perspective view and top view of the second embodiment of the grain boundary diffusion treatment jig according to the present invention.

FIG. 3 is a vertical sectional view of the third embodiment of the grain boundary diffusion treatment jig according to the present invention.

FIGS. 4A and 4B are side views of the fourth embodiment of the grain boundary diffusion treatment jig according to the present invention, and FIG. 4C illustrates a plurality of jigs stacked in a pile.

FIG. 5A is a perspective view of a jig container according to the present invention, and FIG. 5B is a perspective view of a plurality of jig containers stacked in a pile.

FIG. 6 is a side view of a plurality of jig containers stacked in a pile.

FIG. 7 is a side view showing another example of a plurality of jig containers stacked in a pile.

### DESCRIPTION OF EMBODIMENTS

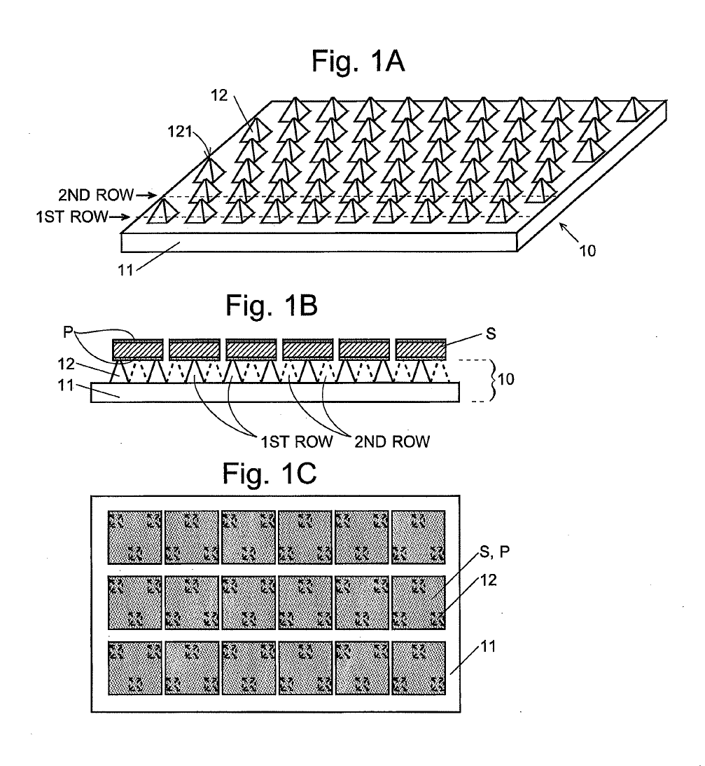

Embodiments of the grain boundary diffusion treatment jig and container according to the present invention will be described using FIGS. 1A-7.

### First Embodiment

A grain boundary diffusion treatment jig 10 of the first embodiment is described using FIGS. 1A-1C. This grain boundary diffusion treatment jig 10 has a large number of projections 12 arranged in a triangular lattice pattern on one side of a plate-shaped base 11. In the present embodiment, alumina (material code: SSA-S; purity 99.5% or higher) is used as the material of the base 11 and the projections 12. It is possible to use zirconia, yttria, steatite, cordierite, titania, silicon nitride, silicon carbide or other materials in place of alumina. The tips 121 of the projections 12 are at the same height.

The projection 12 in the present embodiment has a square pyramid-like shape. A shape different from the square pyramid-like shape may also be used, such as a triangular pyramid-like shape, pyramid-like shape with five or more sides, conical shape, or convex shape (e.g. hemisphere or quarter sphere). For ease of production of the grain boundary diffusion treatment jig 10 by mechanical cutting, a pyramid-like shape with few sides (i.e. triangular or square pyramid) is preferable. Geometrically, the tip of a “pyramid” is a point. However, it is impossible to actually create a projection 12 whose tip 121 is exactly a point. Accordingly, in the present specification, the shape of the projection 12 is described as “pyramid-like.”

In the present embodiment, the projections 12 are arranged in a triangular lattice pattern. An arrangement different from the triangular lattice pattern may also be adopted, such as a square lattice pattern. However, the triangular lattice is more preferable than the square lattice in that it can support one base material S with three projections 12 (FIGS. 1B and 1C) and therefore requires a smaller number of projections 12. In FIG. 1B, the projections 12 shown by the solid line correspond to the projections 12 in the front row (first row) among the rows of projections 12 in FIG. 1A, while those shown by the broken line correspond to the projections 12 in the second row from the front.

This grain boundary diffusion treatment jig 10 is used in the grain boundary diffusion treatment as follows: Initially, an adhesion material P containing R^{H} is applied to the surface of a base material S consisting of a sintered or hot-deformed R^{L}₂Fe₁₄B system magnet. The base material S coated with the adhesion material P is placed on the tips 121 in the grain boundary diffusion treatment jig 10 so as to cover three or more projections 12 (in the example shown in FIGS. 1B and 1C, three projections). In this state, the materials are heated to a predetermined temperature (normally 800° C.-1000° C.), whereby the R^{H} atoms in the adhesion material P are supplied through the grain boundaries of the base material S to regions near the surface of the main phase grains. As a result, an R^{L}₂Fe₁₄B system magnet having an improved coercivity with only a small amount of decrease in the residual magnetic flux density Br and the maximum energy product (BH)ₘₐₓ can be obtained.

Since the tips 121 of the projections 12 in the grain boundary diffusion treatment jig 10 are made of a ceramic material (in the present embodiment, alumina), the tips 121 of the projections 12 will not react with the adhesion material P in the aforementioned heating process. Thus, the fusion of the base material S with the grain boundary diffusion treatment jig 10 is prevented.

As the shape of the tip 121 of the pyramid-like projection 12 becomes closer to a point, the tip 121 becomes easier to be broken. Therefore, the tip should preferably have a polygon-like shape with a side length of 0.1 mm or greater if the projection 12 is in the form of a pyramid (e.g. the previously described square pyramid-like projection 12 should preferably have a square tip), or a circle-like shape with a diameter of 0.1 mm or greater if the projection 12 has a conical shape. On the other hand, if the tip 121 has a polygon-like shape with the side length exceeding 1 mm or a circle-like shape with a diameter of 1.5 mm or greater, the contact area between the tip 121 and the adhesion material P will be too large and a slight reaction may occur between the tip 121 of the projection 12 and the adhesion material P. The tip 121 does not need to be flat; for example, it may have an upward-convex surface. (In other words, the shape of the tip 121 does not need to be a two-dimensional “polygon” or “circle.” Therefore, in this paragraph, those shapes are described as “polygon-like” or “circle-like.”)

Too high a projection is easy to be broken, while too low a projection may allow the adhesion material P to come in contact with the base 11. In the case of the projection 12 in the present embodiment, the height should be 0.5-1.5 times the length of one side of the bottom of the pyramid.

### Second Embodiment

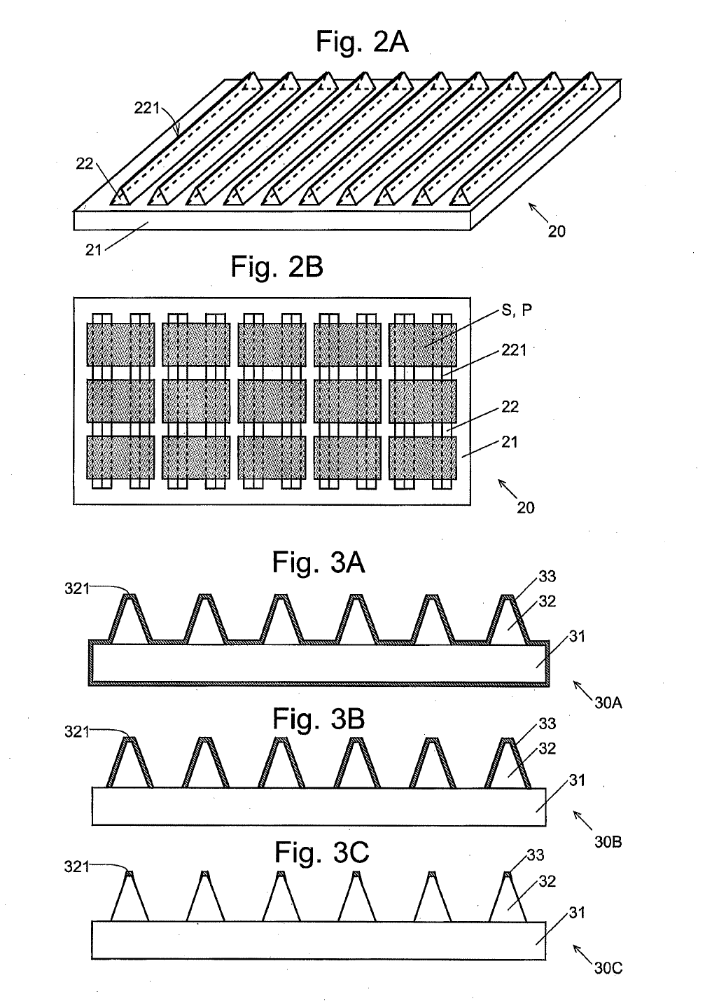

A grain boundary diffusion treatment jig 20 of the second embodiment is described using FIGS. 2A and 2B. This grain boundary diffusion treatment jig 20 has a plate-shaped base 21, on one side of which a large number of projections 22 (each having a tip whose planer shape is linear) are arranged in the form of parallel lines extending in one direction parallel to the aforementioned side. Each projection 22 has a triangular sectional shape perpendicular to its longitudinal direction and a linear tip 221 extending along its longitudinal direction. All the tips 221 of the projections 22 are formed in one plane. The material of the base 21 and the projections 22 is the same as in the first embodiment.

In this grain boundary diffusion treatment jig 20, a base material S coated with an adhesion material P is placed on the tips 221 so as to cover two or more projections 22 (in the example shown in FIG. 2B, two projections), after which the materials are heated to a predetermined temperature to perform the grain boundary diffusion treatment. Compared to the grain boundary diffusion treatment jig 10 of the first embodiment, the grain boundary diffusion treatment jig 20 has a larger contact area between the adhesion material P and the tips 221. However, an advantage exists in that the grain boundary diffusion treatment jig can be easily created with a milling machine or similar device.

### Third Embodiment

Grain boundary diffusion treatment jigs 30A, 30B and 30C of the third embodiment are described using FIGS. 3A-3C. In the third embodiment, a large number of projection-like members 32 are arranged on a plate-shaped base 31. A ceramic coating 33 is formed on the entire surface of the base 31 and the projection-like members 32 in the grain boundary diffusion treatment jig 30A of FIG. 3A, on the entire surface of each projection-like member 32 (exclusive of the base 31) in the grain boundary diffusion treatment jig 30B of FIG. 3B, and on a limited portion including the tip 321 of each projection-like member 32 in the grain boundary diffusion treatment jig 30C of FIG. 3C. Accordingly, in any of these cases, the tips 321 of the projection-like members 32 are covered with the coating 33. The top surfaces of the coatings 33 on the tips 321 of all the projection-like members 32 are at the same height.

In the present embodiment, alumina (material code: SSA-S; purity 99.5% or higher) is used as the material of coatings 33. It is possible to use zirconia, yttria, steatite, cordierite, titania, silicon nitride, silicon carbide or other materials in place of alumina. Carbon is used as the material of the projection-like members 32. Aluminum nitride, stainless steel, titan or other materials can also be used in place of carbon. A ceramic material which is lower in purity (and less expensive) than the material of the coatings 33, or machinable ceramics (which can be easily machined), may also be used as the material of the projection-like members 32.

Similarly to the first embodiment, the arrangement of the projection-like members 32 on the base 31 in the present embodiment is in a triangular lattice pattern. The shape of the projection-like members 32 is a square pyramid. Such an arrangement and shape of the projection-like members 32 can be variously changed as in the case of the projections 12 of the first embodiment. The same arrangement and shape as the projections 22 of the second embodiment may also be adopted.

The grain boundary diffusion treatment jigs 30A, 30B and 30C of the present embodiment can be used in the same way as the grain boundary diffusion treatment jig 10 of the first embodiment.

### Fourth Embodiment

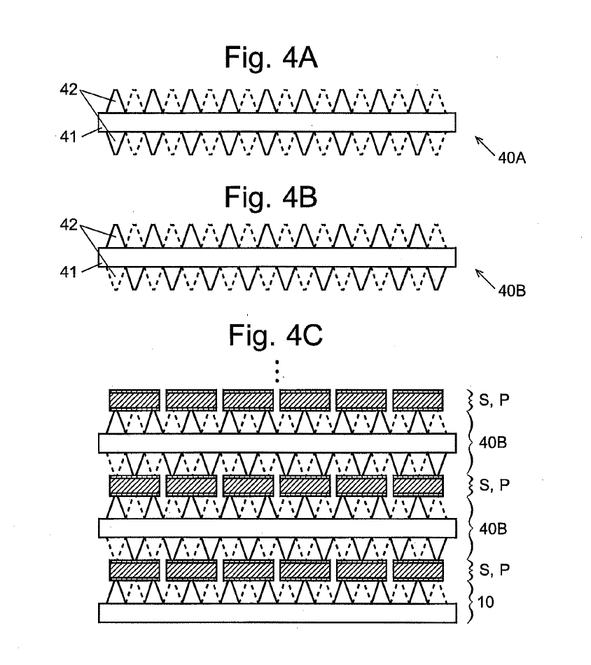

Grain boundary diffusion treatment jigs 40A and 40B of the fourth embodiment are described using FIGS. 4A-4C. In the present embodiment, a large number of projections 42 are arranged on both sides of a plate-shaped base 41. The material of the base 41 as well as the material, shape and arrangement of the projections 42 are the same as the first embodiment. In the grain boundary diffusion treatment jig 40A shown in FIG. 4A, the projections 42 are located at the same positions on both the upper and lower sides of the base 41, whereas, in the grain boundary diffusion treatment jig 40B shown in FIG. 4B, each projection 42 on the lower side of the base 41 is located at the center of gravity of a triangle formed by the lattice points at which the projections 42 on the upper side are located. Compared to the grain boundary diffusion treatment jig 40A, the grain boundary diffusion treatment jig 40B has a smaller difference in the heat capacity of the base 41 between the area with no projection 42 and the area with projections. Therefore, this jig is less likely to undergo thermal strain in a heating or cooling process, and hence less likely to be damaged.

A method of using the grain boundary diffusion treatment jig 40B of the present embodiment is described using FIG. 4C. Although the following description deals with the case of the grain boundary diffusion treatment jig 40B, the method can be similarly applied in the case of using the grain boundary diffusion treatment jig 40A.

After a number of grain boundary diffusion treatment jigs 40B are prepared, a plurality of base materials S coated with an adhesion material P are placed on the upper projections 42 of one of the grain boundary diffusion treatment jigs 40B. Next, another grain boundary diffusion treatment jig 40B is placed on those base materials S, with the lower projections 42 in contact with them. By repeating these operations, the grain boundary diffusion treatment jigs 40B and base materials S are alternately stacked in a pile. It should be noted that the grain boundary diffusion treatment jig 10 of the first embodiment is used as the lowermost grain boundary diffusion treatment jig in the example of FIG. 4C, since this jig does not require lower projections. The pile formed in this manner is heated to a predetermined temperature to perform the grain boundary diffusion treatment.

In the grain boundary diffusion treatment jigs 40A and 40B of the fourth embodiment, a linear projection similar to the one described in the second embodiment may be used as the projection 42. A projection having a coating similar to the one described in the third embodiment may also be used as the projection 42.

### Fifth Embodiment

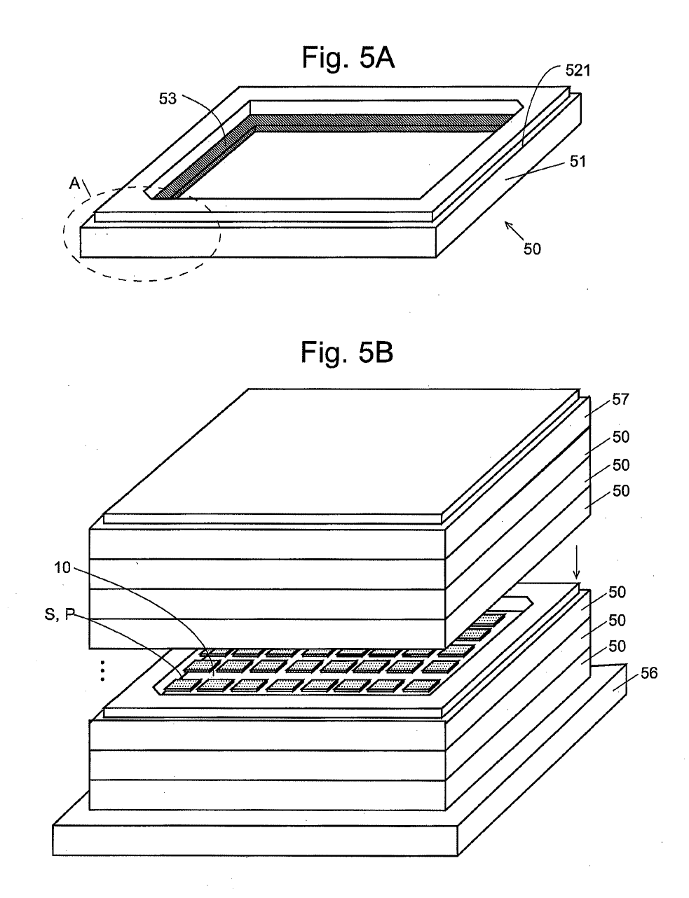

A jig container for grain boundary diffusion treatment according to the present invention is described using FIGS. 5A-5C. The jig container 50 of the present embodiment has: a frame 51 configured to surround the circumference of the rectangular base of a grain boundary diffusion treatment jig to be contained; an upper engaging portion 521 and lower engaging portion 522 respectively formed on the upper and lower sides of the frame 51; and a jig-supporting portion 53 extending from the frame 51 inward. The jig container 50 is made of carbon, a material which is light, easy to be worked, and highly heat-conductive.

The upper engaging portion 521 has a step portion at the outer edge of the frame, while the lower engaging portion 522 has a projecting portion extending downward from the outer edge of the frame. The height of the frame 51 is determined so that the jig containers 50 with their upper and lower engaging portions 521 and 522 fitted together will have a pitch height h greater than the sum of the height h₁ of the base material S and the height h₂ of the grain boundary diffusion treatment jig. The jig-supporting portion 53 has a flat top surface on which the base of the grain boundary diffusion treatment jig is to be placed. The jig-supporting portion 53 itself also has a frame-like shape, with an open space at the center in the lateral direction (i.e. a substantially horizontal direction when in use) of the jig container 50.

Furthermore, in the present embodiment, a pedestal 56 is provided under the lowermost jig container 50, while a cover 57 is provided over the uppermost jig container 50. Similarly to the jig container 50, both pedestal 56 and cover 57 are made of carbon. The pedestal 56 is a plate-shaped member having an area slightly larger than the frame 51 of the jig container 50, and is provided with a pedestal engaging portion 561 consisting of a groove which can be engaged with the lower engaging portion 522 of the jig container 50. The cover 57 is a plate-shaped member having the same area as the frame 51, and is provided with a cover engaging portion 571 having a shape similar to the upper engaging portion 521 of the jig container 50.

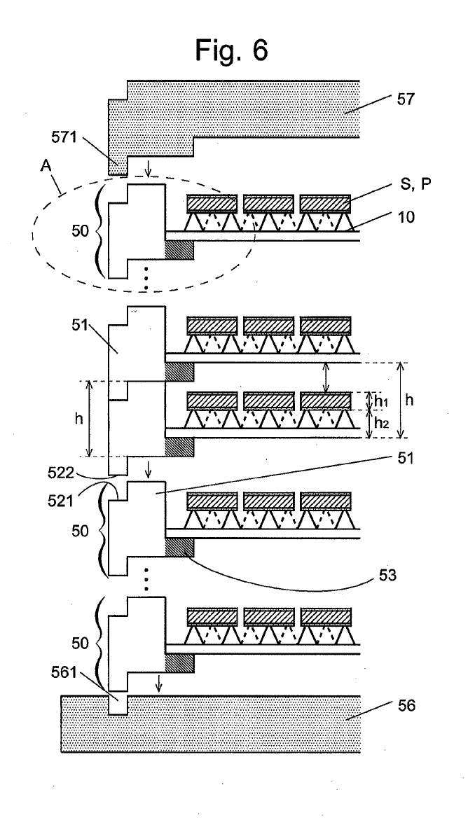

A method of using this jig container 50 is described, taking the example of containing the grain boundary diffusion treatment jig 10 of the first embodiment (see FIGS. 5B and 6). Initially, base materials S coated with an adhesion material P are placed on the projections 12 of the grain boundary diffusion treatment jig 10. Subsequently, this grain boundary diffusion treatment jig 10 is placed in the jig container 53 in such a manner that the circumference of its base 11 is supported by the top surface of the jig-supporting portion 53. A plurality of jig containers 50 in which the grain boundary diffusion treatment jigs 10 have been contained in this manner are stacked, with one container fitted on top of another. The lower engaging portion 521 of the lowermost jig container 50 is fitted in the pedestal engaging portion 561, while the upper engaging portion 521 of the uppermost jig container 50 is engaged with the cover engaging portion 571. Thus, the task of containing the grain boundary diffusion treatment jigs 10 with the base materials S placed thereon is completed. After that, the base materials S and the grain boundary diffusion treatment jigs 10 in the state of being contained in the jig containers 50 are heated to a predetermined temperature to perform the grain boundary diffusion treatment.

In the jig container 50 of the present embodiment, the load of the base materials S and the grain boundary diffusion treatment jigs 10 is supported by the frame 51 of the jig container 50 and will not act on the other base materials S or grain boundary diffusion treatment jigs 10. Therefore, the base materials S and the grain boundary diffusion treatment jigs 10 will not be broken by their own weight.

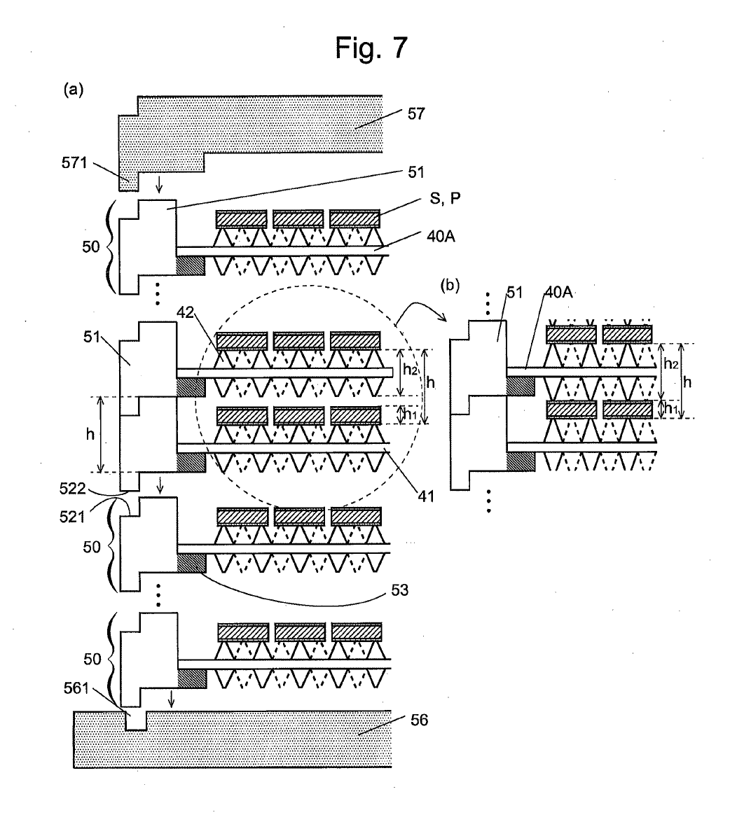

The example shown in FIG. 6 is the case where the grain boundary diffusion treatment jig 10 having the projections 12 only on one side of the base 11 is contained in the jig container 50. As shown in FIG. 7(a), the grain boundary diffusion treatment jig 40A (or grain boundary diffusion treatment jig 40B) with the projections 42 provided on both (obverse and reverse) sides of the base 41 can also be contained in the jig container 50. In this case, the height h₂ of the grain boundary diffusion treatment jig 40A is defined by the vertical distance from the tips of the projections 42 on the lower side of the base 41 to those of the projections 42 on the upper side of the base 41. The pitch height h of the jig container 50 may be greater than the sum of the height h₁ of the base material S and the height h₁ of the grain boundary diffusion treatment jig, or it may be equal to the sum of h₁ and h_{2,} as shown in FIG. 7(b). In any case, even if the projections 42 on the lower side come in contact with the surface of the base material S, fusion is less likely to occur since the contact area is small.

REFERENCE SIGNS LIST
10, 20, 30A-C, 40A, 40B . . . Grain Boundary Diffusion Treatment Jig
11, 21, 31, 41 . . . Base
12, 22, 32, 42 . . . Projection
121, 221, 321 . . . Tip of Projection
33 . . . Coating
50 . . . Jig Container
51 . . . Frame
521 . . . Upper Engaging Portion
522 . . . Lower Engaging Portion
53 . . . Jig-Supporting Portion
56 . . . Pedestal
561 . . . Pedestal Engaging Portion
57 . . . Cover
571 . . . Cover Engaging Portion

1. A plate-shaped jig for a grain boundary diffusion treatment performed in such a manner that an adhesion material containing a heavy rare-earth element R^{H} which is at least one element selected from a group of Dy, Tb and Ho is adhered to a surface of a base material which is a sintered or hot-deformed R^{L}₂Fe₁₄B system magnet containing, as a main rare-earth element, a light rare-earth element R^{L} which is at least one element selected from a group of Nd and Pr, and the base material with the adhesion material is heated, the jig configured to support the base material in the heating process, wherein:
the jig includes a plate-shaped base having a surface with a number of projections arranged so that tips of the projections lie in one plane, and surfaces of the tips are made of a ceramic material.

2. The grain boundary diffusion treatment jig according to claim 1, wherein the projections are projection-like members made of a material different from the ceramic material, with a surface of a tip of each projection-like member coated with the ceramic material.

3. The grain boundary diffusion treatment jig according to claim 1, wherein the ceramic material is alumina, zirconia, titania, silicon carbide, silicon nitride, aluminum nitride, silica, magnesia, yttria, or a compound or mixture of two or more of these materials.

4. The grain boundary diffusion treatment jig according to claim 1, wherein each of the projections has a pyramid-like or convex shape.

5. The grain boundary diffusion treatment jig according to claim 1, wherein the planer shape of the tip of each of the projections is linear.

6. The grain boundary diffusion treatment jig according to claim 1, wherein the projections are formed on both obverse and reverse sides of the plate-shaped base.

7. The grain boundary diffusion treatment jig according to claim 6, wherein the positions of the projections on one side of the base are displaced from the positions of the projections on the other side of the base.

8. A grain boundary diffusion treatment jig container for containing the grain boundary diffusion treatment jig according to claim 1, comprising:
a frame;
an upper engaging portion and a lower engaging portion respectively provided in upper and lower portions of the frame, the upper and lower engaging portions capable of being engaged with each other; and
a supporting portion extending from the frame into an inner space of the frame, the supporting portion configured to support the base of the grain boundary diffusion treatment jig at least at a portion of a circumferential edge of the base,
wherein a pitch height of the jig containers with the upper and lower engaging portions engaged with each other is greater than a sum of a height of a base material to be subjected to the grain boundary diffusion treatment and a height of the grain boundary diffusion treatment jig.

9. A grain boundary diffusion treatment jig container for containing the grain boundary diffusion treatment jig according to claim 6, comprising:
a frame;
an upper engaging portion and a lower engaging portion respectively provided in upper and lower portions of the frame, the upper and lower engaging portions capable of being engaged with each other; and
a supporting portion extending from the frame into an inner space of the frame, the supporting portion configured to support the base of the grain boundary diffusion treatment jig at least at a portion of a circumferential edge of the base, wherein a pitch height of the jig containers with the upper and lower engaging portions engaged with each other is equal to a sum of a height of a base material to be subjected to the grain boundary diffusion treatment and a height of the grain boundary diffusion treatment jig.

10. A grain boundary diffusion treatment jig container for containing a grain boundary diffusion treatment jig, comprising:
a frame;
an upper engaging portion and a lower engaging portion respectively provided in upper and lower portions of the frame, the upper and lower engaging portions capable of being engaged with each other; and
a supporting portion extending from the frame into an inner space of the frame, the supporting portion configured to support a base of the grain boundary diffusion treatment jig at least at a portion of a circumferential edge of the base, wherein a height of the frame is greater than a sum of a height of a base material to be subjected to the grain boundary diffusion treatment and a height of the grain boundary diffusion treatment jig.

11. The grain boundary diffusion treatment jig container according to claim 8, wherein the frame is made of carbon.

12. The grain boundary diffusion treatment jig container according to claim 9, wherein the frame is made of carbon.

13. The grain boundary diffusion treatment jig container according to claim 10, wherein the frame is made of carbon.
